(19) United States
(12) Patent Application Publication
(10) Pub. No.: US 2010/0308771 A1
(43) Pub. Date: Dec. 9, 2010

(54) SYSTEM AND METHOD FOR PROTECTION OF BATTERY PACK

(76) Inventor: William DENSHAM, Los Gatos, CA (US)

Correspondence Address: PATENT PROSECUTION;O2MIRCO , INC., 3118 PATRICK HENRY DRIVE, SANTA CLARA, CA, 95054, US

(21) Appl. No.: 12/783,697

(22) Filed: May 20, 2010

Related U.S. Application Data
(60) Provisional application No. 61/184,060, filed on Jun. 4, 2009.

(51) Int. Cl. H02J 7/00

(52) U.S. Cl. 320/134; 320/136

(57) ABSTRACT

A battery system includes a battery pack, an electrical interface and a load discharging the battery pack. The battery pack is used to provide a power supply and includes a monitor which is configured to monitor a battery status of the battery pack. The electrical interface is coupled to the battery pack for transmitting the power supply and the battery status. The load is coupled to the battery pack through the electrical interface, and receives the power supply to discharge the battery pack and receives the battery status via a first communication bus to control the discharging of the battery pack based on the battery status.

### RELATED APPLICATION

This application claims priority to U.S. Provisional Application No. 61/184,060, filed on Jun. 4, 2009, which is hereby incorporated by reference in its entirety.

### BACKGROUND

FIG. 1 shows a diagram of a conventional battery system 100. The battery system 100 includes a battery pack 102, a charger 104 to charge the battery pack 102, and a load 106 (e.g., a power tool or a motor of an electrical vehicle) powered by the battery pack 102. The battery pack 102 includes a controller 112 to control and protect the charging process when the charger 104 is charging the battery pack 102, and to control and protect the discharging process when the load 106 is discharging the battery pack 102. The charger 104 includes a controller 114 and communicates with the battery pack 102 via a serial communication bus 120. The battery pack 102 sends battery information, such as battery temperature, battery state-of-charge, battery current, and battery identification to the charger 104 via the serial communication bus 120. Similarly, the charger 104 can send charger information such as charger authentication/identification, charging current, and charging voltages to the battery pack 102 via the serial communication bus 120. The load 106 utilizes a controller 116 to control the operation of the load 106. For example, the controller 116 can be a motor speed controller to control the speed of a motor of an electrical vehicle.

However, since the battery pack 102 powers the load 106 via a power line 140, the load 106 may not know the battery information such as individual battery cell voltages and cell temperatures. Consequently, the battery pack 102 may be damaged when powering the load 106 due to undesirable or fault conditions of the battery pack 102, e.g., over-temperature, under-temperature, under-voltage, or even cell reversal conditions. The battery pack 102 may include a charging switch and a discharging switch, and the controller 112 of the battery pack 102 can control the switches to protect the battery pack 102 from being damaged. However, the controller 112 is relatively expensive, and the charging and discharging switches generate cell damage heat inside the battery pack 102.

### SUMMARY

A battery system includes a battery pack, an electrical interface, and a load discharging the battery pack. The battery pack is used to provide a power supply and includes a monitor which is configured to monitor a battery status of the battery pack. The electrical interface is coupled to the battery pack for transmitting the power supply and the battery status. The load is coupled to the battery pack through the electrical interface, and receives the power supply to discharge the battery pack and receives the battery status via a first communication bus to control the discharging of the battery pack based on the battery status.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 shows a diagram of a conventional battery system.

FIG. 2 shows a diagram of a battery system, in accordance with one embodiment of the present invention.

FIG. 3 shows a diagram of an electrical interface, in accordance with one embodiment of the present invention.

FIG. 4 shows a diagram of a monitor, in accordance with one embodiment of the present invention.

FIG. 5 shows a flowchart of a method for charging and discharging a battery pack, in accordance with one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

According to one embodiment of present invention, a battery system in which a battery pack is capable of communicating a battery status with a load via a first communication bus and communicating with a charger via a second communication bus is disclosed. Advantageously, the load and the charger can respectively control discharging and charging of the battery pack based on monitored battery status sent from the battery pack via the corresponding communication buses. As such, the controller, the charging switch, and the discharging switch in the battery pack can be eliminated. System safety and functionalities can be improved while the cost can be reduced by partitioning monitor and control elements in the battery pack, the load, and the charger.

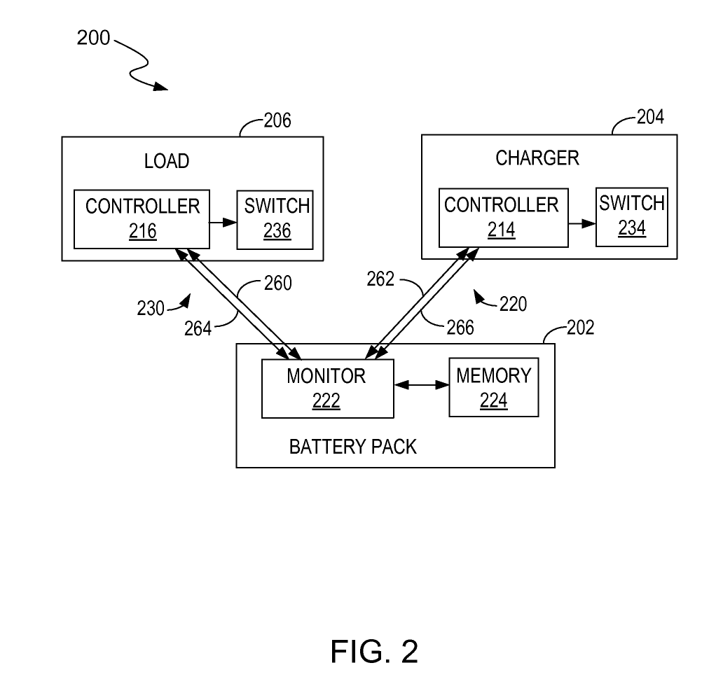

FIG. 2 shows a diagram of a battery system 200, in accordance with one embodiment of the present invention. The battery system 200 includes a battery pack 202, a charger 204 to charge the battery pack 202, and a load 206, e.g., a power tool or a motor in an electrical vehicle, to discharge the battery pack 202. In one embodiment, the battery pack 202 includes one or more battery cells. The battery pack 202 further includes a monitor 222 to monitor a battery status including, but not limited to, battery operating statuses, such as battery/cell temperatures, battery/cell voltages, battery current, and battery/cell state-of-charge of the battery pack 202, and battery identification/authentication information. The battery pack 202 is coupled to the charger 204 via a transmission bus 220. In one embodiment, the transmission bus 220 includes a communication bus 262 and a power bus 266. The battery pack 202 communicates the battery status to the charger 204 via the communication bus 262 and is charged by the charger 204 via the power bus 266. The charger 204 includes a controller 214 to monitor a charger status which includes, but is not limited to, charger authentication/identification, charging current, and charging voltages. Similarly, the charger 204 communicates the monitored charger status to the battery pack 202 via the communication bus 262.

The battery pack 202 is coupled to the load 206 via a transmission bus 230. In one embodiment, the transmission bus 230 includes a communication bus 260 and a power bus 264. The battery pack 202 communicates the battery status to the load 206 via a communication bus 260 and powers the load 206 via the power bus 264. The load 206 includes a controller 216 to monitor a load status which includes, but is not limited to, load authentication/identification, discharging current, discharging voltage, and motor speed if the load 206 includes a motor. Consequently, the battery pack 202 and the load 206 can communicate the monitored battery status and the load status via the communication bus 260. Advantageously, if undesirable or fault conditions, e.g., over-temperature, under-temperature, under-voltage, or cell reversal conditions, happens during the battery pack 202 powering the load 206, the monitor 222 monitors the battery status to detect the undesirable or fault conditions and notifies the load 206. Thus, the load 206 can disable the discharging, and the battery pack 202 as well as the load 206 can be protected from being damaged.

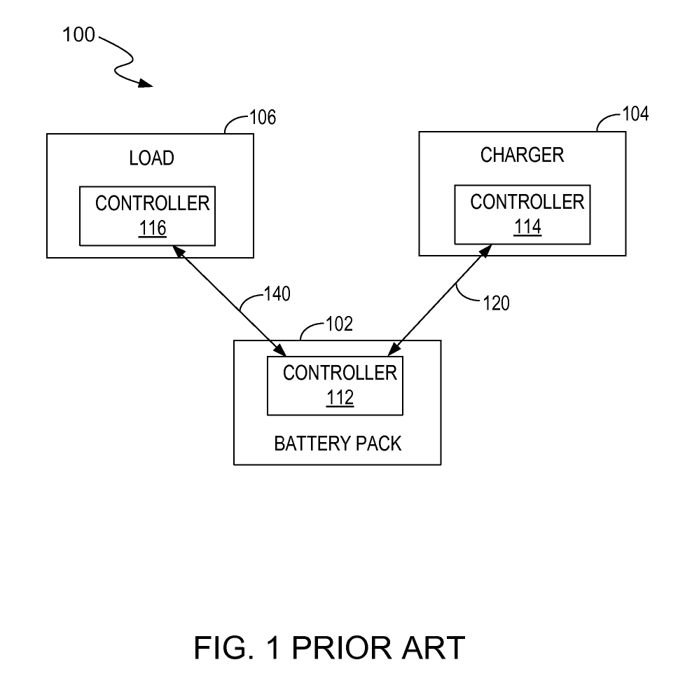

Advantageously, as the battery pack 202, the load 206 and the charger 204 employ the monitor 222, the controller 216 and the controller 214 to monitor the battery status, the load status and the charger status separately, monitoring accuracy can be enhanced. Meanwhile, since the monitor 222, which is low-cost, is employed by the battery pack 202 instead of the controller 112 in the battery pack 102 in the prior art FIG. 1, the discharging control ability is thus transferred to the controller 216 in the load 206. The controller 216 of the present invention can share the same hardware topology while expanding the function of the conventional controller 116 of the load 106 in FIG. 1. Consequently, the total system cost and the size can be reduced.

In one embodiment, the battery status monitored by the monitor 222, the charger status monitored by the controller 214, and the load status monitored by the controller 216 can be converted into digital signals. The communication buses 260 and 262 can be serial communication buses. As used herein, “serial communication” means the process of sending a signal one bit at one time, sequentially, over a communication channel or bus. The serial communication bus can be, but is not limited to, serial peripheral interface (SPI) bus, inter-integrated circuit (I²C) bus, and 1-wire bus. The communication buses 260 and 262 can be designed to conform to the same standard, e.g., the I²C bus standard. Alternatively, the communication buses 260 and 262 can be parallel communication buses. The “parallel communication” means transmitting signals over several wires simultaneously over several parallel channels.

In one embodiment, the battery pack 202 further includes a memory 224 coupled to or integrated inside the monitor 222. The memory 224 stores a usage history of the battery pack 202. For example, the usage history includes the battery statuses that each time the battery pack 202 operated. Advantageously, the usage history in the memory 224 can be accessed by a computer for analysis.

In one embodiment, the load 206 can further include a discharging switch 236 controlled by the controller 216. The load 206 utilizes the discharging switch 236 to control the discharging process based on the battery status sent by the monitor 222. If the battery status indicates that the battery pack 202 undergoes an undesirable or fault condition, e.g., under-voltage, the load 206 can terminate the discharging process by turning off the discharging switch 236.

Similarly, the charger 204 can further include a charging switch 234 controlled by the controller 214. The charger 204 utilizes the charging switch 234 to control the charging process based on the battery status sent by the monitor 222. If the battery status indicates that the battery pack 202 undergoes an undesirable or fault condition, e.g. under-temperature, over-temperature, over-voltage, the charger 204 can terminate the charging process by turning off the charging switch 234.

Therefore, the load 206 and the charger 204 can control the discharging and charging processes by controlling the discharging switch 236 and the charging switch 234, respectively. Advantageously, the controller, the charging switch and the discharging switch in the battery pack 102 in FIG. 1 can be eliminated. Accordingly, the size and cost of the battery pack 202 are reduced.

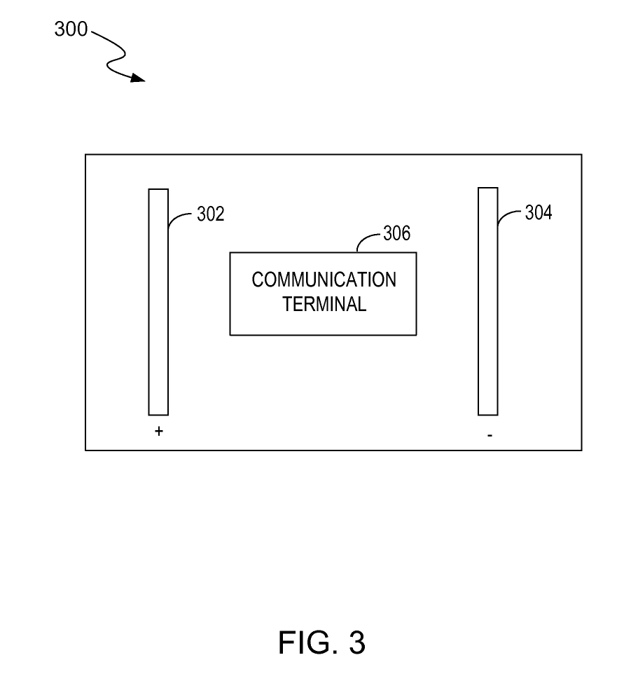

In one embodiment, the battery pack 202 is coupled to the load 206 and charger 204 through electrical interfaces, respectively. The electrical interface is discussed in relation to FIG. 3. In one embodiment, the electrical interface between the battery pack 202 and the load 206 conforms to the same standard as the electrical interface between the battery pack 202 and the charger 204. Therefore, the battery pack 202 can include one electrical interface shared by the load 206 and the charger 204. Alternatively, the battery pack 202 can include two identical electrical interfaces that allow the battery pack 202 to be coupled to the load 206 and the charger 204 simultaneously. Yet in another embodiment, the electrical interface between the battery pack 202 and the load 206 complies with a standard which differs from the standard of the electrical interface between the battery pack 202 and the charger 204. In such circumstance, the battery pack 202 can include two different electrical interfaces, for the load 206 and the charger 204, respectively.

FIG. 3 shows a diagram of an electrical interface 300 between the battery pack 202 and the load 206 or between the battery pack 202 and the charger 204, in accordance with one embodiment of the present invention. FIG. 3 is described herein with reference to the battery system 200 in FIG. 2. The electrical interface 300 includes power terminals, e.g., a positive terminal 302 and a negative terminal 304, and a communication terminal 306. The positive terminal 302 and the negative terminal 304 are configured to transmit charging or discharging power and support the power buses 264 and 266 in FIG. 2. In one embodiment, the positive terminal 302 is coupled to a positive terminal of the load 206 or the charger 204 in FIG. 2. Similarly, the negative terminal 304 is coupled to a negative terminal of the load 206 or the charger 204 in FIG. 2. Alternatively, the negative terminal 304 can be coupled to ground.

The communication terminal 306 is configured to transfer the signals indicative of the battery status, the load status and the charger status, and support the communication buses 260 and 262 in FIG. 2. For example, the battery pack 202, the load 206 and the charger 204 each employs the same electrical interface 300. During charging, the charger 204 charges the battery pack 202 through the positive terminal 302 and the negative terminal 304 via the power bus 266 in FIG. 2, and communicates with the battery pack 202 through the communication terminal 306 via the communication bus 262 in FIG. 2. The battery pack 202 can power the load 206 through the positive terminal 302 and the negative terminal 304 via the power bus 264 in FIG. 2, and transmit the battery status of the battery pack 202 to the load 206 through the communication terminal 306 via the communication bus 260 in FIG. 2.

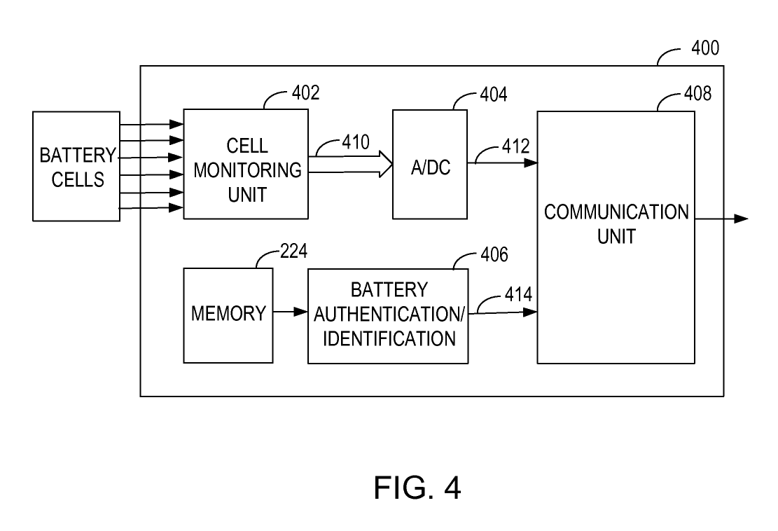

FIG. 4 shows a diagram of a monitor 400 of the battery pack 202, in accordance with one embodiment of the present invention. FIG. 4 is described in combination with FIG. 2 and FIG. 3. The monitor 400 includes a cell monitoring unit 402, an analog to digital convertor (A/DC) 404, a battery authentication/identification 406, and a communication unit 408.

The cell monitoring unit 402 is coupled to each battery cell in the battery pack 202 for individually monitoring the battery cells, and generating monitoring signals 410 indicating statuses of the battery cells, such as battery/cell temperatures, battery/cell voltages, battery current, and battery/cell state-of-charge of the battery pack 202. In one embodiment, the monitoring signals 410 are analog signals, and the A/DC 404 converts the monitoring signals 410 to digital signals 412. The battery authentication/identification 406 can be stored in the memory 224 which is described in FIG. 2, and outputs battery authentication/identification digital signals 414. The communication unit 408 receives the battery status digital signals 412 and the battery authentication/identification digital signals 414, and communicates the battery status of the battery pack 202 to the controller 216 of the load 206 or the controller 214 of the charger 204 in FIG. 2, through the communication terminal 306 in FIG. 3.

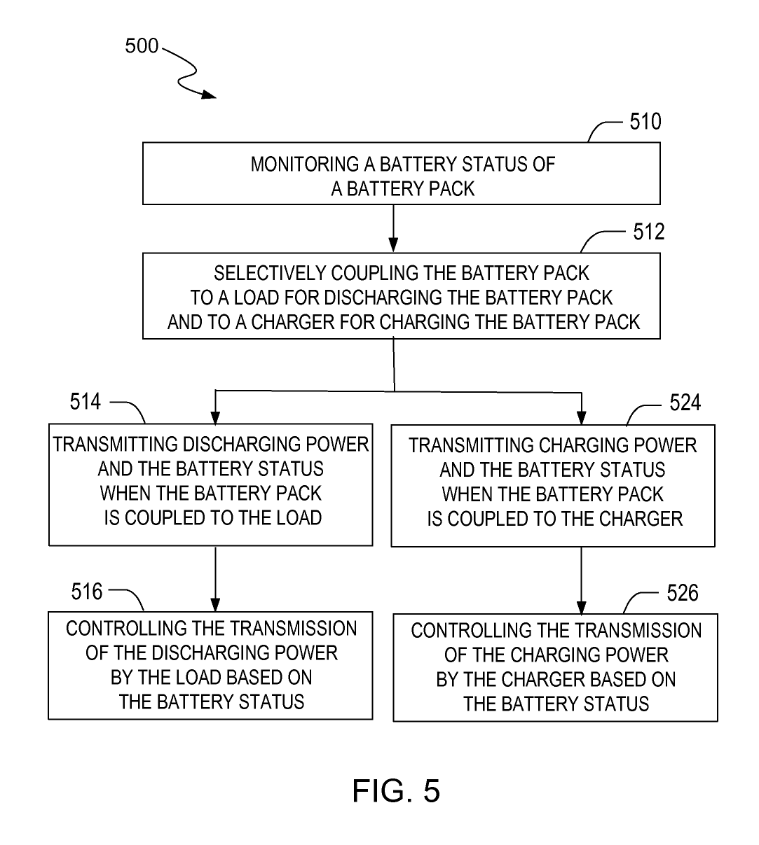

Referring to FIG. 5, a method 500 for charging and discharging a battery pack is illustrated, in accordance with one embodiment of the present invention. Although specific steps are disclosed in FIG. 5, such steps are just examples. That is, the present invention is well suited to performing various other steps or variations of the steps recited in FIG. 5. FIG. 5 is described in combination with FIG. 2 and FIG. 3.

In block 510, a battery status of a battery pack 202 is monitored. The battery status includes, but is not limited to, battery/cell temperatures, battery/cell voltages, battery current, battery/cell state-of-charge, and battery authentication/identification of the battery pack 202.

In block 512, the battery pack 202 is selectively coupled to a load 206 or a charger 204. In one embodiment, the battery pack 202 includes one electrical interface 300 in FIG. 3 for coupling the battery pack 202 to the load 206 or the charger 204 when the electrical interface 300 can be shared by the load 206 and the charger 204. In another embodiment, the battery pack 202 includes two electrical interfaces when the electrical interface between the battery pack 202 and the load 206 differs from the electrical interface between the battery pack 202 and the charger 204.

In block 514, the discharging power and signals indicative of the battery status of the battery pack 202 are transmitted to the load 206. The discharging power can be transmitted through power terminals 302 and 304 of the electrical interface 300 in FIG. 3, and the battery status can be transmitted through a communication terminal 306 of the electrical interface 300. In one embodiment, the load 206 includes a controller 216 for monitoring a load status of the load 206. The load status includes, but is not limited to, load authentication/identification, discharging current, discharging voltages of the load 206, and motor speed if the load 206 includes a motor.

In block 516, the controller 216 controls the transmission of the discharging power based on the battery status. Meanwhile, the controller 216 can control the transmission of the discharging power based on the load status.

In block 524, the charging power and signals indicative of the battery status of the battery pack 202 are transmitted. The charging power can be transmitted from the charger 204 to the battery pack 202 through power terminals 302 and 304 of the electrical interface 300 in FIG. 3, and the battery status of the battery pack 202 can be transmitted through a communication terminal 306 of the electrical interface 300. In one embodiment, the charger 204 includes a controller 214 for monitoring a charger status of the charger 204. The charger status includes, but is not limited to, charger authentication/identification, charging current, and charging voltages.

In block 526, the controller 214 controls the transmission of the charging power based on the battery status. Meanwhile, the controller 214 can control the transmission of the charging power based on the charger status.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A battery system, comprising:
a battery pack operable for providing a power supply, said battery pack comprising a monitor which is configured to monitor a battery status of said battery pack;
a first electrical interface coupled to said battery pack and operable for transmitting said power supply and said battery status; and
a load coupled to said battery pack through said first electrical interface and operable for receiving said power supply to discharge said battery pack, and for receiving said battery status via a first communication bus to control discharging of said battery pack based on said battery status.

2. The battery system of claim 1, wherein said load comprises a controller operable for monitoring a load status of said load, and for communicating said load status to said battery pack via said first communication bus.

3. The battery system of claim 2, wherein said load further comprise a discharging switch controlled by said controller, and is operable for terminating said discharging by turning off said discharging switch.

4. The battery system of claim 1, wherein said battery pack further comprises a memory coupled to said monitor and operable for storing said battery status.

5. The battery system of claim 4, wherein said battery status stored in said memory is accessible by a computer.

6. The battery system of claim 1, further comprising:
a charger for charging said battery pack, wherein said charger receives said battery status from said battery pack via a second communication bus, and controls said charging based on said battery status.

7. The battery system of claim 6, wherein said charger comprises a controller operable for monitoring a charger status of said charger, and for communicating said charger status to said battery pack via said second communication bus.

8. The battery system of claim 7, wherein said charger further comprise a charging switch controlled by said controller, and is operable for terminating said charging by turning off said charging switch.

9. The battery system of claim 6, further comprising:
a second electrical interface coupled between said charger and said battery pack.

10. The battery system of claim 9, wherein said second electrical interface comprises a communication terminal for transmitting said battery status from said battery pack to said charger via said second communication bus.

11. The battery system of claim 1, wherein said first electrical interface further comprises a power terminal for delivering said power supply from said battery pack to said load.

12. The battery system of claim 1, wherein said first electrical interface comprises a communication terminal for supporting said first communication bus.

13. The battery system of claim 1, wherein said monitor comprises:
a cell monitoring unit coupled to each cell of a plurality of battery cells in said battery pack, and for monitoring said battery cells and generating a plurality of monitoring signals indicating statues of said battery cells;
an analog to digital convertor (A/DC) coupled to said cell monitoring unit and for converting said monitoring signals to digital signals respectively; and
a communication unit coupled to said A/DC for generating said battery status based on said digital signals, and for communicating said battery status.

14. A system comprising:
a battery pack including a monitor which is configured to detect a battery status of said battery pack;
a load including a first controller which is configured to control a discharging of said battery pack based on said battery status when said battery pack is coupled to said load for discharging;
a charger including a second controller which is configured to control a charging of said battery pack based on said battery status when said battery pack is coupled to said charger for charging; and
a transmission bus for selectively coupling said battery pack to said load and to said charger, said transmission bus further operable for transmitting discharging power and said battery status when said battery pack is coupled to said load module, and for transmitting charging power and said battery status when said battery pack is coupled to said charger.

15. The system of claim 14, wherein said transmission bus comprises:
a power bus for selectively transmitting said charging power and said discharging power; and
a communication bus for transmitting said battery status of said battery pack to said load and said charger.

16. The system of claim 15, wherein said communication bus comprises a serial communication bus.

17. The system of claim 14, further comprising:
a memory coupled to said monitor and operable for storing said battery status.

18. A method for charging and discharging a battery pack, said method comprising:
monitoring a battery status of said battery pack;
selectively coupling said battery pack to a load for discharging said battery pack, and to a charger for charging said battery pack;
transmitting discharging power and said battery status when said battery pack is coupled to said load;
controlling transmission of said discharging power by said load based on said battery status;
transmitting a charging power and said battery status when said battery pack is coupled to said charger; and
controlling transmission of said charging power by said charger based on said battery status.

19. The method of claim 18, further comprising:
monitoring a load status of said load; and
controlling transmission of said discharging power based on said load status.

20. The method of claim 18, further comprising:
monitoring a charger status of said charger; and
controlling transmission of said charging power based on said charger status.
